(19) United States
(12) Patent Application Publication
(10) Pub. No.: US 2018/0356942 A1
(43) Pub. Date: Dec. 13, 2018

(54) METHOD FOR DISPLAYING 360º MEDIA ON BUBBLES INTERFACE

(71) Applicant: SAMSUNG ELETRÔNICA DA AMAZÔNIA LTDA., Campinas (BR)

(72) Inventors: RENATA ZILSE PEREIRA BORGES, Campinas (BR); Rodrigo José Tobias, Campinas (BR); Marcos Henrique De Souza Muniz, Manaus (BR); Antonio Marcos Marcon, Campinas (BR)

(73) Assignee: SAMSUNG ELETRÔNICA DA AMAZÔNIA LTDA., Campinas (BR)

(21) Appl. No.: 15/695,532

(22) Filed: Sep. 5, 2017

(30) Foreign Application Priority Data
Jun. 12, 2017 (BR) 1020170125173

(51) Int. Cl. G06F 3/0481; G06F 3/0488; G06F 3/0485; G06F 3/0486

(52) U.S. Cl. CPC G06F 3/0481; G06F 3/0488; G06F 3/0485; G06F 2203/04808; G06F 2203/04802; G06F 2203/04806; G06F 3/0486

(57) ABSTRACT

A method for displaying 360° media on a bubbles interface of a touch screen/display/virtual projections includes providing an interface configured for a user to navigate through a plurality of bubbles, wherein each bubble of the plurality of bubbles includes at least one of a tridimensional, spherical format, shape, and surface, and each bubble of the plurality of bubbles represents at least one of a video and a photo, wherein the interface comprises: providing at least one interaction for the user with each bubble using at least one of a tapping, clicking, pinching, stretching, multiple touching, drag and drop, rotation, and long press action; providing a navigation movement through the plurality of bubbles in a three-dimensional manner; and grouping the plurality of bubbles in the interface by a user-defined classification including at least one of a date, time, location, tag, and category.

### CROSS-REFERENCE TO RELATED APPLICATIONS

This application claims the foreign priority benefit of Brazilian Patent Application No. 10 2017 0125173, filed on Jun. 12, 2017 in the Brazilian Intellectual Property Office, the disclosure of which is incorporated herein by reference.

### BACKGROUND

### Field

The following description relates to a method for displaying panoramic content in electronic devices, composed by spherical items (like “soap bubbles”, or any other spherical items, like “globes”, “balls”, “balloons”, etc.), in order to provide a better, verisimilar, and more accurate display of 360° content (e.g. video and images generated by 360° cameras). This method is performed on a device with touch screen/display (e.g. smartphones, tablets, PCs), a Virtual Reality headset/glass, Augmented Reality headset/glass and/or a smart TV screen.

### Description of Related Art

Nowadays, many specialized cameras have been developed for the purpose of generating 360° content (videos and/or images). These cameras are commercially available to general consumers, which enable them to capture the whole space-time and somehow “freeze that complete moment in history”. It is not correct to consider the 360° camera as an evolution that directly derives from another previous market camera. In fact, the 360° camera is a new and unprecedented device—its essence, use and possibilities are different.

Additionally, due to the availability of powerful devices as smartphones and VR/AR headsets/glasses, it is possible to use this 360° content in order to provide more immersive experiences. In other words, through smartphones and Virtual Reality headset/glass, Augmented Reality headset/glass and 360° content, it is possible to “revive” those “complete moments” previously recorded by a 360° camera.

The 360° image capturing is closely related to both the established world of “normal”) (non-360°) photography and video, and the emerging world of Virtual Reality (VR), Augmented Reality (AR) and Mixed Reality (MR). The 360° format can be defined by its combination of high levels of immersion combined with its capturing of “real” images. For this reason, 360° format can be defined as immersive live action.

The 360° content is not about simple videos or photos. It brings freedom, interaction and protagonism, with an unprecedented viewer experience, the perspective of looking is enhanced. The viewer/user abandon the vision imposed by the first person (a single view, to where the camera “was pointed”) and start to see the shared vision of the third person (a complete view of the entire environment); that is, the user is not a simple viewer anymore, but becomes a participant of the scene. The current technology allows the user to revive a recorded (space-time) experience, and gives the chance to people who have not lived that moment to experience it.

In summary, in the user perspective, the keyword to 360° technologies is empathy, because it captures entire experiences to be revived in an immersive way (virtual—but unconcealed—reality), which makes the viewer/participant physically and emotionally understand that recorded (space-time) experience.

However, on the other hand, the current existing graphical user interfaces (GUI) are not able to properly display and represent 360° content. More specifically, the 360° video/images are spherical (3D aspect), but the interfaces that represent this kind of content are flat/rectangular (2D aspect).

For many years, graphical user interface has become a standard on personal computer and mobile industry. An interface is a set of information, commands/controls and/or menus/navigation displayed on a screen, through which a user is able to communicate with a program. In a broad sense, user interface is the part of an information system with which a person/user may interact. Despite the occasional evolutions and innovation, the user interface field is much consolidated in the computer and mobile industry.

Another relevant technology in the computer and mobile industry is touchscreen technology. Touchscreen is layered on the top of visual displays/screens of many current devices (smartphones, tablets, PCs, etc.), and enables the user to directly control and interact with what is displayed (i.e. the screen/display itself becomes the input device, rather than a keyboard, a mouse, a touchpad, etc.).

Finally, one of the most relevant technologies related to the present disclosure is 360° content (video/photo). The 360° content is an audiovisual simulation/representation of an environment that surrounds the user/viewer, an immersive media technology that is changing the way a viewer interacts with live streaming video, video on demand, virtual tours, etc. The 360° contents are video recordings wherein a view in every direction is recorded at the same time, shot using an omnidirectional camera or a collection/array of cameras. The resulting footage is then stitched (by the camera itself, or by a video editor software) to form a single 360° video. During playback, the user/viewer controls the viewing direction, looking around in all directions (360°, very similar to real life) of the video/photo by using a mobile device's accelerometers and also by using AR/VR headsets. Although the hardware to create 360° VR content exists for years, the technology for a better user experience does not exist yet.

The paper titled “THE BUBBLE USER INTERFACE: A TANGIBLE REPRESENTATION OF INFORMATION TO ENHANCE THE USER EXPERIENCE IN IPTV SYSTEMS”, by R. Bernhaupt, M. Pirker and A. Desnos (available online at https://hal.archives-ouvertes.fr/hal-01133701/document, accessed on November 2016) presents a user interface as a tailor-made alternative to current list or grid menus in order to not only address current limitations of list and grid menus, but to offer a novel and unique way to interact with TV content. The solution proposed by this paper is an evolution/adaptation to provide a better user experience and meet the consumers' needs for natural, straightforward and pleasant method of interacting with their IPTV systems (an industry which has evolved—from few channels to a connected home entertainment environment with multiple screens—and demanded new requirements). But this solution requires an input device (hardware) for interaction, which resembles a sphere/orb and containing buttons, so that the user can manipulate the soap bubbles in the graphical interface. This paper differs from the present disclosure because it requires additional hardware and it is not related to 360° content.

The paper titled “GESTURE INTERACTION WITH A BUBBLE USER INTERFACE: ENHANCING THE USER EXPERIENCE”, by R. Bernhaupt, M. Pirker, D. Schwaiger, and A. Desnos (available online at http://digital-library.theiet.org/content/conferences/10.1049/ib.2014.0012, PDF available, accessed on November 2016) is quite similar to the previous work (paper mentioned above). This paper differs from the present disclosure because it requires additional hardware and it is not related to 360° content.

The paper titled “INTRODUCING KUPLA UI: A GENERIC INTERACTIVE WALL USER INTERFACE BASED ON PHYSICS MODELED SPHERICAL CONTENT WIDGETS”, by K. Kuikkaniemi, M. Vilkki, J. Ojala, M. Nelimarkka and G. Jacucci (https://www.researchgate.net/publication/262170255_Introducing_Kupla_UI_A_generic_interactive_wall_user_interface_based_on_physics_modeled_spherical_content_widgets, PDF available, accessed on November 2016) presents a generic user interface for large interactive walls, Kupla UI. In the paper, it is not disclosed what kind of user interactions can be done, and what are the respective effects of these user interactions. Kupla UI applies physics modeled spherical content widgets to present information. It is primarily targeted for multi-user information exploration and for informal presentations in public spaces, such as exhibitions, commercial spaces and lobbies. Kupla is designed to support multiple simultaneous users, graph-based content hierarchy, flexibly changing installation form-factors, heterogeneous content, and playful interaction. Because this solution/system can be applied to many kind of contents (including traditional documents and web content), this system requires dedicated web-based content management system (to configure/manage the contents). This solution differs from the present disclosure because it requires a dedicated content management system and it is not related to 360° content.

### SUMMARY

As described above, 360° content is a new paradigm of the space-time capture. The present disclosure is aligned with this new paradigm, providing a novel interface to present, interact and navigate among 360° content (videos and photos). More specifically, it is an interface to present 360° contents in a tridimensional spherical way, like soap bubbles.

In the context of the present disclosure, despite the specificity of the term “bubble” or “soap bubble”, actually we are supposed to include any other possible spherical format/shape/surface, e.g.: “ball”, “globe”, “balloon”, or even semi-spherical (concave or convex half spheres), etc. Hereinafter, we will use the term “bubble” to designate any tridimensional spherical format/shape that also meets the requirements of the present disclosure, i.e., “a tridimensional, spherical format/shape/surface in the interface which enables the user to preview and rotate 360° content”. Each bubble is an event and can be rotated and manipulated giving a little preview of the image. The bubbles can be translucent or opaque.

In the method of the present disclosure, the user can navigate through a plurality/universe of bubbles, wherein each bubble represents one recorded/captured moment (video or photo) that can be pre-visualized: if the bubble represents a movie, then a short trailer/portion of this movie can be previewed in looping; otherwise, if the bubble represents a photo, then it shows the static image.

The bubbles can have different sizes to represent importance level (e.g.: ranking, priority, how many times user accessed/viewed that content, etc.). Also, the gallery display varies: the bubbles can be attracted by date, location, tag/category, etc. These “visual attractions” (visual organization of the bubbles) can be selected through the gallery menu/settings (user defined).

According to the method, the user interacts in different ways with a specific bubble. All the controls/commands can be made by possible interactions with a touch screen, e.g.: tapping, clicking, pinching, stretching, double/multiple touching, drag and drop, long press, etc.

The proposed method goes beyond the existing solutions in the prior art, because: (i) it does not require additional hardware modification or a dedicated content management system; (ii) it simulates the 3D aspect of a sphere (bubbles), which can be rotated (and so favoring 360° view).

Usage/application scope is very large, since it is possible to apply the proposed method on multiple types of smartphones, tablets, Virtual Reality headset/glass, Augmented Reality headset/glass, smart TVs, wearables, any device with a touch screen/display.

### BRIEF DESCRIPTION OF THE DRAWINGS

The patent or application file contains at least one drawing executed in color. Copies of this patent or patent application publication with color drawings will be provided by the Office upon request and payment of the necessary fee. The objectives and advantages of the present disclosure will become clearer through the following detailed description of the example and non-limitative figures presented at the end of this document, wherein:

FIG. 1 discloses view of the original content (360°, spherical, 3D) and its flat/rectangular representation (2D) according to the prior art interfaces;

FIG. 2 discloses an interface displayed according to an embodiment of the method of the present disclosure;

FIG. 3 discloses a schematic view exemplifying how to rotate a bubble according to an embodiment of the method of the present disclosure;

FIG. 4 exemplifies how to move a specific bubble according to an embodiment of the method of the present disclosure;

FIG. 5 discloses the action of a click/press in a specific bubble, which opens/plays the 360° content (video or photo) through a video player/image viewer;

FIG. 6 discloses the action of long click/press in a specific bubble, which presents a graphical menu with some possible options/actions associated with the specific bubble;

FIG. 7 discloses the horizontal navigation/scroll (left and right) through the gallery (axis-x);

FIG. 8 discloses the vertical navigation/scroll (up and down) through the gallery (axis-y);

FIG. 9 discloses the navigation through the gallery's axis-z (go back and go forward);

FIG. 10 discloses the method to group/cluster the bubbles through a user-defined classification according to an embodiment of the method of the present disclosure; and

FIG. 11 illustrates another embodiment for the proposed method of the present disclosure, similar to the FIG. 2, but now using other technology devices.

### DETAILED DESCRIPTION

The following description is presented to enable any person skilled in the art to make and to use the embodiments, and is provided in the context of particular applications and their requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the principles and features herein disclosed.

The present disclosure does not only provide technical advantages and new features, but also a method which allows a more emotional and immersive experience regarding the presentation and interaction of 360° content (video/images). The proposed method is suited for the purpose of 360° content, which allows the user to relive the recorded experience/moment, or even more, give the possibility to people who did not live that moment to (virtually) live it. The 360° camera goes beyond the capture of space; it allows you to capture the space-time and freeze that moment in history.

As it will become clear from the detailed description, the method of the present disclosure can be embedded/applied/used on a plurality of devices, such as those having a touch screen/display such as smartphones, tablets, notebooks/PCs, smart TVs, Virtual Reality headset/glass, Augmented Reality headset/glass and alike.

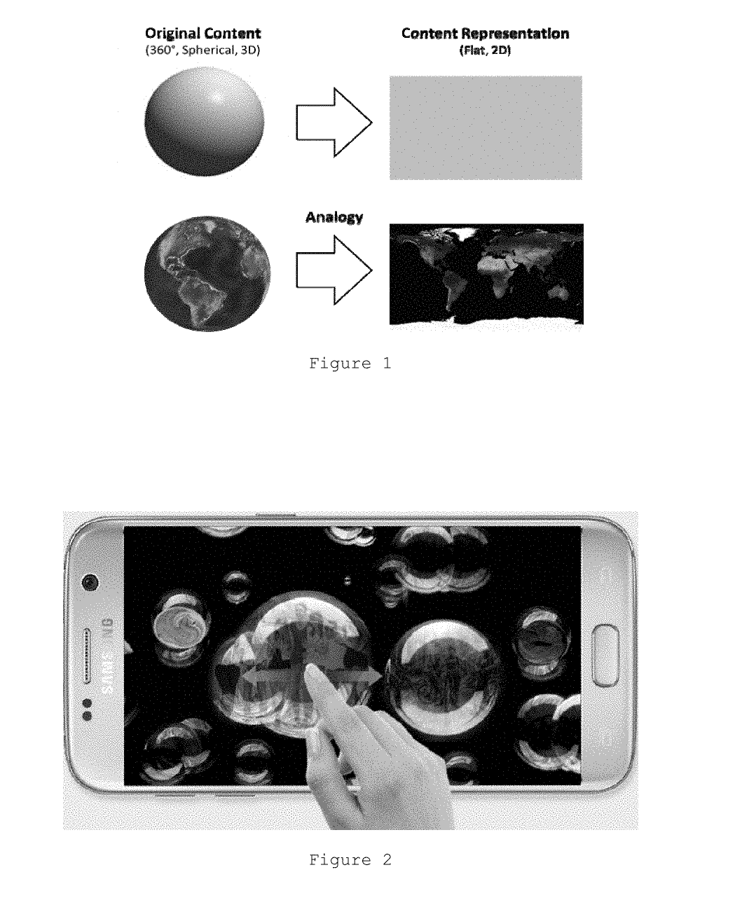

FIG. 1 illustrates how the original content (360°, spherical, 3D) is represented by the prior art interfaces in a flat/rectangular representation (2D aspect), which is not the best possible representation.

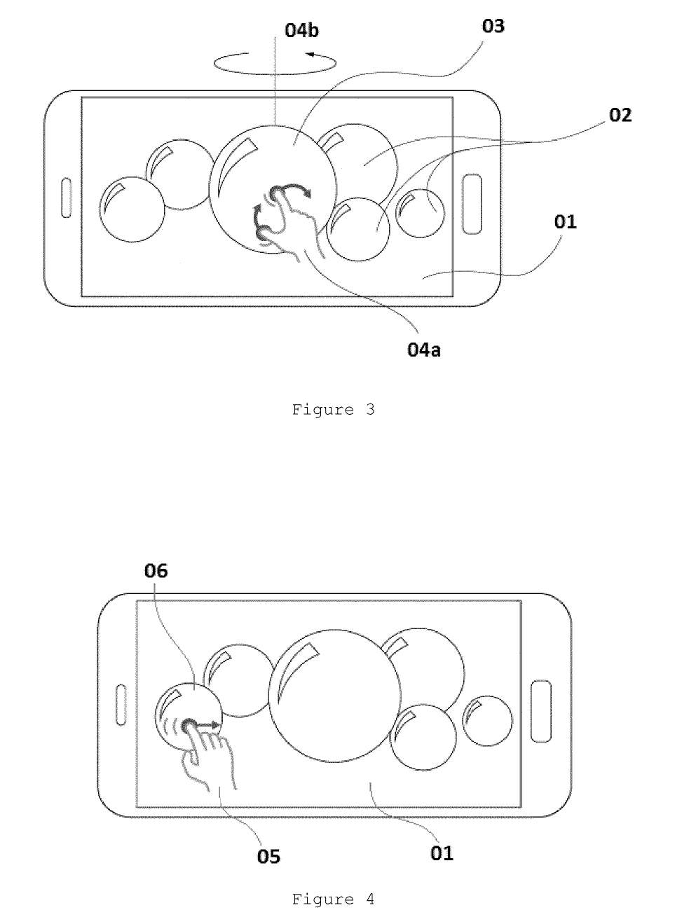

FIG. 2 illustrates an embodiment of the method of the present disclosure, which innovates with a new way of showing 360° images gallery. In the method of the present disclosure, the user navigates through a plurality/universe of bubbles on the interface/gallery, wherein each bubble represents one recorded/captured moment (video or photo) that can be previewed: if the bubble represents a movie, then a short trailer/portion of this movie can be previewed in looping (e.g.: repeating some few seconds of the 360° video); otherwise, if the bubble represents a photo, then it shows the static image. All the controls/commands can be made by possible interactions with a touch screen, e.g.: tapping, clicking, pinching, stretching, double/multiple touching, drag and drop, long press, etc.

The bubbles have different sizes to represent importance level (e.g.: ranking, priority, how many times user accessed/viewed that content, etc.). Also, the gallery display varies: the bubbles can be attracted by date, location, tag/category, etc. These “visual attractions” (visual organization of the bubbles) can be selected through the gallery menu/settings.

Some examples and embodiments of the method for displaying panoramic content are presented below. Nevertheless, the present disclosure is not limited to these specific cases, examples and embodiments. Someone skilled in the art can clearly notice that the proposed method could be implemented with other features, commands/interactions and graphical elements, without deviating the spirit and the scope of the present disclosure.

In FIG. 3, in according to an embodiment of the disclosure, the interface/gallery (01) is composed of a plurality/universe of bubbles with different sizes (02). The user interacts in different ways with a specific bubble (03). For example, the user double touches the specific bubble (03) and performs a combined rotation movement (04a) in the touch screen, which makes the bubble (03) to spin over one of its axis (04b), providing a complete/rotating view of the 360° content of the bubble (03).

In FIG. 4, another example of interaction is shown when the user drags and drops (05) a specific bubble (06), moving it—changing its position—on the interface/gallery (01).

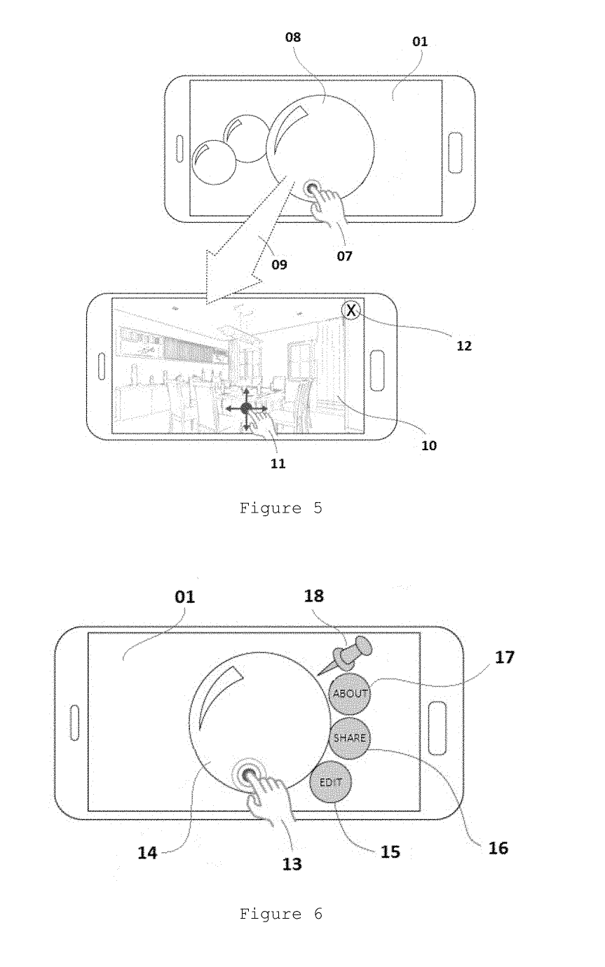

FIG. 5 shows other possible interaction according to the method for displaying an interface/gallery (01). When user simple clicks/presses (07) a specific bubble (08), it opens/plays (09) the 360° content (10), which can be either a video or photo, through a video player/image viewer (which can be either gallery embedded or standalone). The viewer/player provides a method (11) to completely visualize (all directions) the 360° content (10), and a method to stop (12) the content display and go back to the interface/gallery (01) screen.

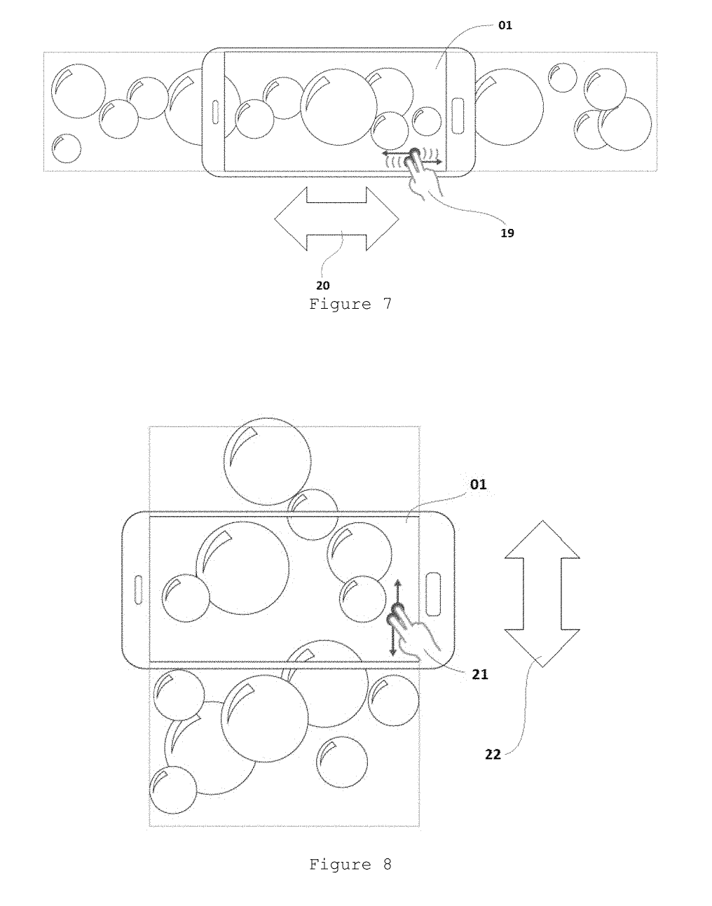

FIG. 6 discloses a similar interaction, but now with a long click/press. In the interface/gallery (01), the user performs a long click/press (13) on a specific bubble (14). This long click/press (13) presents a graphical menu associated with the specific bubble (14), with some possible options/actions, for example (but not limited to): edit (15), share (16), about/properties (17) and a pin/needle (18) to “explode” the specific bubble (14) and delete the associated 360° content. As mentioned, it is important to note that there could be other options/actions, or the graphical menu could be presented in alternative formats.

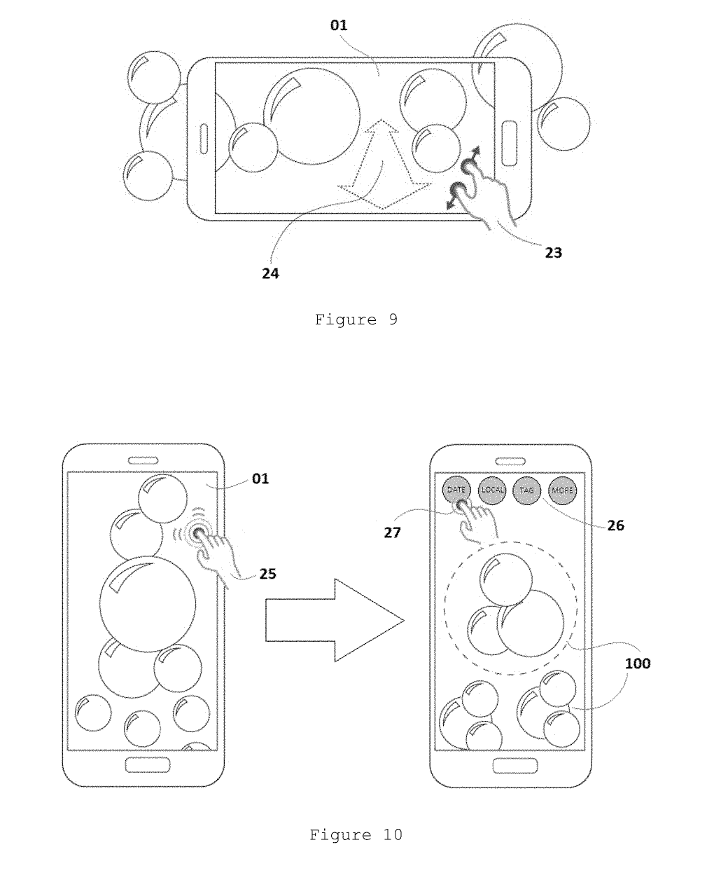

It is also possible to navigate (horizontally: left/right; vertically: up/down; go forward/go back; zoom in/zoom out) through the plurality/universe of bubbles in the gallery/interface. According to FIG. 7, the user can horizontally navigate/scroll (20) through the gallery (axis-x), for example, by touching/pressing the interface (01) simultaneously with two fingers (19) and then sliding to left and right as desired. Analogously, as depicted in FIG. 8, the user also vertically navigates/scrolls (22) through the gallery (axis-y), for example, by touching/pressing the interface (01) simultaneously with two fingers (21) and then sliding to up and down as desired. According to FIG. 9, if the gallery is represented as a 3D space, the user navigates through the gallery's axis-z (24), for example, by touching/pressing the interface (01) with two fingers (23) and then pinching (to go back) and stretching (to go forward) as desired. Otherwise, if the gallery is represented as a 2D space, then the same pinching and stretching movement (23) respectively performs zoom out and zoom in effect.

The method of the present disclosure also comprises an interface having a method to group/cluster the bubbles by a user-defined classification (e.g.: date/time, location, tag/category, etc.), as illustrated on FIG. 10. For example, when the user double touches/clicks (25) an empty space on the interface (01), a menu (26) is activated wherein the user can choose/select (27) the criteria to group/cluster the bubbles (100). The result is that the gallery display varies: the bubbles can be attracted by date/time, location, tag/category, etc. This feature is implemented by many of existing clustering algorithms, recommendation systems, etc.

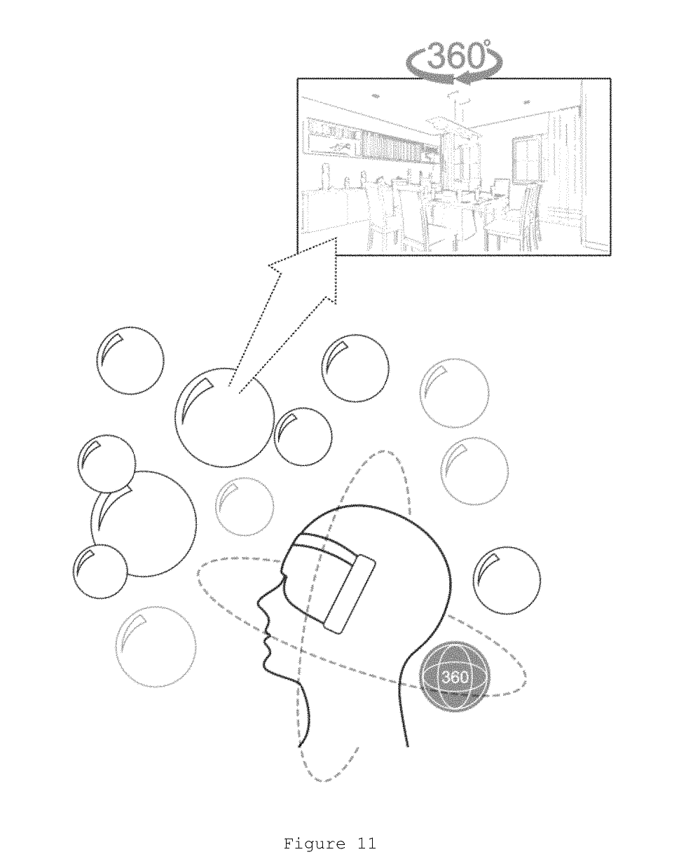

FIG. 11 illustrates another embodiment for the proposed method of the present disclosure, similar to the FIG. 2, but now using other technologies like Virtual Reality headset/glass in a plurality of scenarios like the domestic dinner's room. This proposed method can also be used in another physical device but in other technologies like Augmented Reality headset/glass and/or a smart TV screen. All proposed devices innovate with a new way of showing 360° images gallery.

As mentioned before, the present disclosure is not limited to these specific cases, examples and embodiments. For example, despite it is not illustrated or detailed in the present description, it is clear that the method implementing that interface can be used/viewed through the Virtual Reality headset/glass, Augmented Reality headset/glass (instead of mobile, tablet, PC, etc.), wherein the viewing can be even more immersive and natural. As the user moves his/her head with the headset, he/she can navigate (horizontally, vertically, back and forward) along the virtual gallery, among a universe of bubbles. Using the Gear VR touchpad, the user is able to perform clicks, touches, pinching, stretching and other actions that he/she already performs on a mobile touchscreen, for instance.

Although the present disclosure has been described in connection with certain embodiments, it should be understood that it is not intended to limit the disclosure to those particular embodiments. Rather, it is intended to cover all alternatives, modifications and equivalents possible within the spirit and scope of the disclosure as defined by the appended claims.

1. A method for displaying 360° media, the method comprising:
providing an interface configured for a user to navigate through a plurality of bubbles, wherein each bubble of the plurality of bubbles includes at least one of a tridimensional, spherical format, shape, and surface, and each bubble of the plurality of bubbles represents at least one of a video and a photo,
wherein the interface comprises
providing at least one interaction or the user with each bubble using at least one of a tapping, clicking, pinching, stretching, multiple touching, drag and drop, rotation, and long press action;
providing a navigation movement through the plurality of bubbles in a three-dimensional manner; and
grouping the plurality of bubbles in the interface by a user-defined classification including at least one of a date, time, location, tag, and category.

2. The method of claim 1, wherein the plurality of bubbles have different sizes representing an importance level based on at least one of a ranking, priority, and a number of times a user has accessed each bubble of the plurality of bubbles.

3. The method of claim 1, wherein the rotation action is configured to rotate a bubble of the plurality of bubbles, providing a complete rotatable view of 360° content of the bubble.

4. The method of claim 3, wherein the rotation action is performed when the user performs the multiple touch action on the bubble and performs the rotation action on the bubble.

5. The method of claim 1, wherein the at least one of interaction changes a position of at least one bubble in the plurality of bubbles.

6. The method of claim 5, wherein the at least one interaction is the drag and drop action performed on the at least one bubble.

7. The method of claim 1, wherein the at least one interaction includes executing the 360° media of the bubble through at least one of a video player and an image viewer.

8. The method of claim 7, wherein the 360° media is executed when the user performs the clicking action on the bubble.

9. The method of claim 1, wherein the at least one interaction includes presenting a graphical menu associated with the bubble, the graphical menu including at least one of an edit, share, about, properties, and a graphical pin to explode the bubble and delete the associated 360° media.

10. The method of claim 9, wherein the graphical menu appears when the user performs the long press action on the bubble.

11. The method of claim 1, wherein the user performs the navigation movement in at least one of a left and right direction by performing the touching action simultaneously with two fingers and then sliding in the at least one of the left and right direction.

12. The method of claim 1, wherein the user performs the navigation movement in at least one of an up and down direction by performing the touching action simultaneously with two fingers and then sliding to in the at least one of the up and down direction.

13. The method of claim 1, wherein the user performs the navigation movement in at least one of a forward and back direction by performing the touching action simultaneously with two fingers and then performing at least one of the pinching action and the stretching action.

14. The method of claim 1, wherein the grouping the plurality of bubbles is further performed by the user performing the clicking action on an empty space on the interface, and activating a menu wherein the user selects the classification to group the plurality of bubbles.

15. The method of claim 1, wherein at least one bubble of the plurality of bubbles includes a preview animation of a video in the 360° media associated with the bubble.
